(19) United States
(12) Patent Application Publication
(10) Pub. No.: US 2026/0075567 A1
(43) Pub. Date: Mar. 12, 2026

(54) METHODS AND APPARATUSES FOR ARTIFICIAL INTELLIGENCE BASED USER EQUIPMENT POSITIONING ESTIMATION

(71) Applicant: SHENZHEN TCL NEW TECHNOLOGY CO., LTD., Shenzhen, Guangdong (CN)

(72) Inventor: Ahmed MOHAMMED MIKAEIL SALIH, Shenzhen, Guangdong (CN)

(73) Assignee: SHENZHEN TCL NEW TECHNOLOGY CO., LTD., Shenzhen, Guangdong (CN)

(21) Appl. No.: 19/106,204

(22) PCT Filed: Aug. 25, 2022
(86) PCT No.: PCT/CN2022/114900

§ 371 Date: Feb. 24, 2025

(51) Int. Cl. H04W 64/00; H04L 41/16; H04W 24/10

(52) U.S. Cl. CPC H04W 64/00; H04L 41/16; H04W 24/10

(57) ABSTRACT

This disclosure proposed a method, which introduces a new AI, based positioning related function at a NG-RAN node to allow a UE to select between applying an AI and non-AI positioning model for UE location estimation and/or to allow the UE to select an appropriate AI model among different AI positioning models based on an indication provide by the UE. The method furtherly defines the measures based on which the AI or non-AI model can be selected for UE positioning estimation and defines the related signaling procedures that allow proper interaction between different NR positioning related node nodes.

### BACKGROUND OF DISCLOSURE

### 1. Field of the Disclosure

The present disclosure relates to the field of wireless communication systems, more particularly; to methods and apparatuses for direct artificial intelligence/machine learning (AI/ML) based positioning estimation. More specifically the disclosure is related to enhancing the radio access network (RAN) signaling and procedures of the new radio (NR) specification to support direct AI-based positioning methods for improving the user equipment (UE) location estimation accuracy.

### 2. Description of the Related Art

In 3GPP RAN #94 meeting, a new study item (SI) on artificial intelligence/machine learning (AL/ML) for NR air interface has been approved with the main goal of exploring the benefits of enhancing the air interface with features enabling an improved support of AI/ML-based algorithms for enhanced performance and/or reduced complexity/overhead. The aims of this study item focus on studying a few carefully selected use-cases like CSI feedback, beam management and positioning accuracy enhancement, with the goal of identifying the areas where AI/ML could improve the performance of the air-interface functions.

Regarding the positioning enhancement use case, it was agreed in 3GPP RAN1 #109 meeting to study two options of AI/ML based positioning method in Release-18 NR specification. The first option is a direct AI/ML based positioning method in which an AI/ML model is supposed to replace the existing positioning methods to provide the final UE location estimate. The second option is an indirect AI/ML positioning method or AI-assisted method in which an AI model is used to assist an existing positioning method to enhance the UE location estimation. In this meeting, it was also agreed to further study and provide inputs on potential specification impact of AI/ML positioning approaches in terms of AI/ML model indication/configuration aspects e.g., the assistance signaling and procedures for model configuration, model activation/deactivation, model recovery/termination, and model selection.

For direct AI/ML based positioning, it was argued in many contributions submitted to 3GPP RAN1 #109 meeting that this option might suffer from some technical aspects. These aspects include an increased signaling overhead or complexity issues due to requirement of introducing of a new types of positioning measurements, model generalization issue when changing UE scenarios, backward compatibility issue with the existing NR positioning methods, and high requirement of processing or computational resources at the entity where the direct AI/ML based positioning is to be deployed. Therefore, apparatuses and methods, or procedures or signaling enhancements are required to allow an effective integration of such a direct AI/ML positioning model into NR specification while taking into account the above-mentioned technical aspects.

### SUMMARY

An object of the present disclosure is to propose methods and apparatuses for direct artificial intelligence/machine learning (AI/ML) based positioning model for user equipment (UE) location estimation.

In a first aspect of the present disclosure, a method for direct AI/ML based positioning model for user equipment (UE) location estimation performed by a communication network system comprising: employing a direct AI positioning related function or information element at the radio access network (RAN) entity or at the access and mobility management function (AMF) and/or at the location management function (LMF) entity of the communication network system, wherein the direct AI positioning related function allows the node responsible for UE location estimation (e.g.,. UE or LMF) to select a suitable AI/ML model among different AI models and/or to perform adaptive selection between applying a direct AI positioning method or a non-AI positioning method based on a set of parameters or configuration at communication network system entity and/or based on explicit or implicit indications delivered via a signaling message from the node responsible for final location estimation; wherein the set of the parameters or the indications comprises at least one of the following parameters: An existing AI or non-AI positioning model performance errors, a limitation on processing capability of the entity where an AI positioning model is deployed e.g., a UE type information, a required positioning accuracy level as indicated by application requiring UE location estimation; and/or a processing load or overhead or computational resources availability status at the entity where the AI model is deployed positioning.

In a second aspect of the present disclosure, a communication network system comprises a memory, a transceiver, and a processor coupled to the memory and the transceiver. The processor is configured to perform the above method.

In a third aspect of the present disclosure, a non-transitory machine-readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of NR positioning system architectures with different AI positioning model location and collaboration options according to an embodiment of the present disclosure.

FIG. 2 is a schematic diagram illustrating an example of direct AI based positioning and AI-assisted positioning methods according to an embodiment of the present disclosure.

FIG. 3 is a schematic diagram illustrating an example of proposed NR positioning system architectures with direct-AI related positioning function is located at gNB according to an embodiment of the present disclosure.

FIG. 4 is a schematic diagram illustrating an example of proposed NR positioning system architectures with direct-AI positioning related function is located at AMF/LMF according to an embodiment of the present disclosure.

FIG. 5 is a schematic diagram illustrating an example of NR positioning system architectures assuming no UE-Network collaboration, the Direct-AI model is located at UE side and the AI positioning related function located at gNB or AMF/LMF side according to an embodiment of the present disclosure.

FIG. 6 is a schematic diagram illustrating an example of NR positioning system architectures assuming no UE-Network collaboration option, the Direct-AI positioning model is located at gNB side, and the AI positioning related function located at gNB or AMF/LMF side according to an embodiment of the present disclosure.

FIG. 7 is a schematic diagram illustrating an example of NR positioning system architectures assuming no UE-Network collaboration option, and the direct-AI model is located at LMF/AMF and the AI positioning related function located at gNB or AMF/LMF side according to an embodiment of the present disclosure.

FIG. 8 is a schematic diagram illustrating an example of NR positioning system architectures assuming collaboration with AI model transfer from gNB to UE according to an embodiment of the present disclosure.

FIG. 9 is a schematic diagram illustrating an example of NR positioning system architectures assuming collaboration with AI model transfer from LMF to UE according to an embodiment of the present disclosure.

FIG. 10 is a schematic diagram illustrating an example of AI-model indication provided within location measurement indication RRC signaling response from UE to gNB according to an embodiment of the present disclosure.

FIG. 11 is a schematic diagram illustrating an example of AI-model indication provided within a positioning information NR-PPa signaling request from LMF to gNB according to an embodiment of the present disclosure.

FIG. 12 is a schematic diagram illustrating an example of RRC signaling configuration 0/1 for exchanging model transfer related info from gNB to UE according to an embodiment of the present disclosure.

FIG. 13 is a schematic diagram illustrating an example of a model transfer related message provided within positioning information response or update message NR-Positioning Protocol A NR-PPa signaling response from gNB to LMF according to an embodiment of the present disclosure.

FIG. 14 is a block diagram of a communication network system according to an embodiment of the present disclosure.

FIG. 15 is a flowchart illustrating a method for direct AI/ML based positioning model for user equipment (UE) location estimation according to an embodiment of the present disclosure.

FIG. 16 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

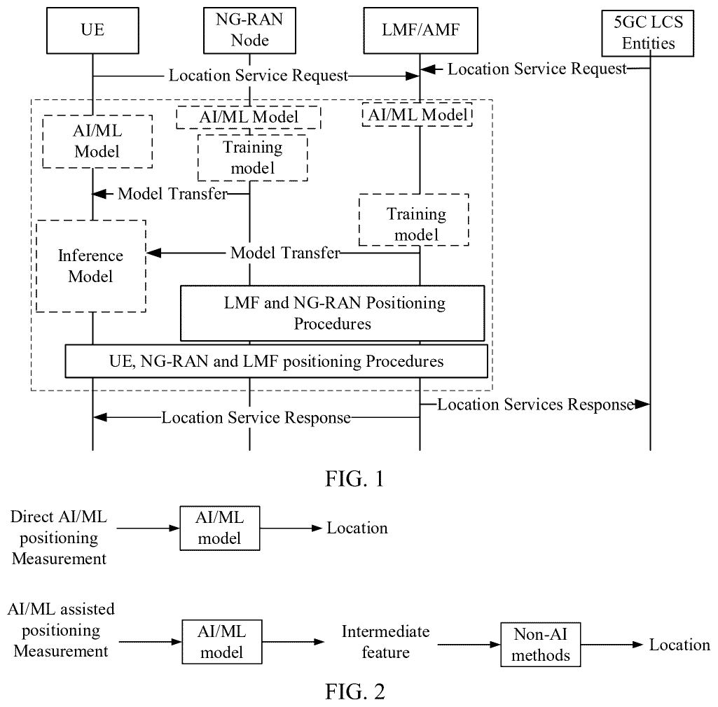

In 3GPP RAN #94 meeting, a new study item (SI) on artificial intelligence/machine learning for NR air interface has been approved with the main goal of exploring the benefits of enhancing the air interface with features enabling an improved support of AI/ML-based algorithms for enhanced performance and/or reduced complexity/overhead. The aims of this study item is to focus on studying a few carefully selected use-cases like CSI feedback, beam management and positioning accuracy enhancement, with the goal of identifying the areas where AI/ML could improve the performance of air-interface functions and studying the common AI/ML framework, including functional requirements of AI/ML architecture, and the specification impact that would be required to enable using of AI/ML techniques for improving the air interface performance. Regarding NR AI positioning accuracy enhancements, it was agreed in in 3gpp RAN1 #109 meeting, to further study different location of AI based positioning model e.g., AI model one side or one entity (UE, gNB or LMF) ; where, both training and inference are conducted at either, or partial AI model at one side; where, the training and inference are conducted at one side of network or UE, but requires additional signaling or procedure enhancements between two sides, potentially with existing signaling framework. Moreover, it has been also agreed in this meeting to consider different levels of network-UE collaboration e.g., no collaboration, signaling-based collaboration without model transfer and signaling-based collaboration with model transfer for further considerations (FIG. 1), and to further study AI/ML model generalization aspect for NR positioning.

In addition to the above agreements, it was also agreed in RAN1 #109 meeting to further study the following AI/ML based positioning enhancement including: a) Direct AI based positioning: where an AI-based method is can replace the existing positioning methods and can be utilized to estimate UE location with the reference to a new type of measurements and/or measurement reports such as the amplitude or power, the time of arrival (TOA), angle of arrival (AoA), channel impulse response (CIR), the beam index, the transmission and reception points (TRP) index, and/or reflection order of signal received from multiple TRPs (FIG. 2). b) Indirect or AI-assisted positioning: where AI is used to assist an existing positioning method to enhance the UE location estimation e.g., by extracting an intermediate feature from measurements and/or measurement reports such as downlink-reference signal timing difference (DL-RSTD), DL-angle of departure (DL-AoD), uplink-relative time of arrival (UL-RTOA), uplink sounding reference signal-reference signal received power (SRS-RSRP), DL positioning reference signal RSRP (DL PRS-RSRP), UE Rx-Tx time difference and gNB Rx-Tx time difference, UL-AOA or AoD or zenith angle of arrival (ZOA) values per path; then, estimating the final UE position according to the extracted intermediate feature (FIG. 2).

In this report we focus on direct AI based positioning method, as this method may require introducing of new measurements and/or exchanging additional information or procedures which may increase overhead and/or system complexity or reduces network efficiency, suffers from poor AI model generalization capability due to scenarios changes since a trained AI/ML model is strongly related to specific scenario or geographical distribution, suffers from backward compatibility with the existing non-AI based positioning methods and does not take into account the processing capability or computational resource availability of the entity where the direct AI-based position model is to be deployed or located. Therefore, it is not clear how the direct AI/ML positioning model can be integrated into NR specification while keeping a tradeoff between signaling overhead, complexity, model generalization aspects, backward compatibility issue, processing capability or computational resources availability at the entity where AI/ML positioning model is located, and the degree of the positioning accuracy level which can be achieved by adopting a direct AI-based positioning approach for UE positioning estimation. Some embodiments of this disclosure propose a method for effective integration of direct AI-based positioning model taking the above technical aspects considerations into account.

To achieve a tradeoff between the above technical aspects and the positioning accuracy level that could be achieved by adopting a direct AI-based positioning estimation model, this disclosure proposed to introduce a direct AI-positioning related function or information element to the existing NR specification e.g., at gNB and/or AMF/LMF entity. The role of the function is to act as a managing entity for AI/ML positioning model, responsible for AI/ML model indication/configuration aspects such as AI model activation/deactivation, model recovery/termination, model selection and model transfer aspects irrespective of the entity where model is deployed and/or the level of collaboration required between these entities. The major goal of direct AI-positioning related function is to allow the node responsible for UE location estimation (e.g., UE or LMF) to select an appropriate model among different AI/ML positioning models and/or to perform adaptive selection between applying a direct AI/ML positioning method or a non-AI positioning method UE location estimation. The selection of a suitable AI model among different AI models or between applying AI/ML or non-AI positioning method can be based on a set of an existing parameters or configuration at the node responsible for positioning estimation. Alternatively, the selection can be also on a set of parameters or explicit or implicit indications delivered via signaling messages from the node responsible for final location estimation. The set of the parameters or the indications for AI model selection may comprise at least one of the following parameters: An existing AI or non-AI positioning model performance errors, a limitation on processing capability of the entity where an AI positioning model is deployed e.g., a UE type information, a required positioning accuracy level as indicated by application requiring UE location estimation; and/or a processing load or overhead or computational resources availability status at the entity where the AI positioning model is deployed (gNB, UE, LMF).

To support different direct AI/ML positioning model location options and different collaboration levels, a different level of procedures and interactions signaling between the UE, LMF and related AI direct-positioning function at gNB or LMF are also introduced or defined in this disclosure. The details of these signaling and procedures are given in some embodiments as below.

Embodiment 1: The signaling and procedures considering the direct-Ai positioning function is located at gNB:

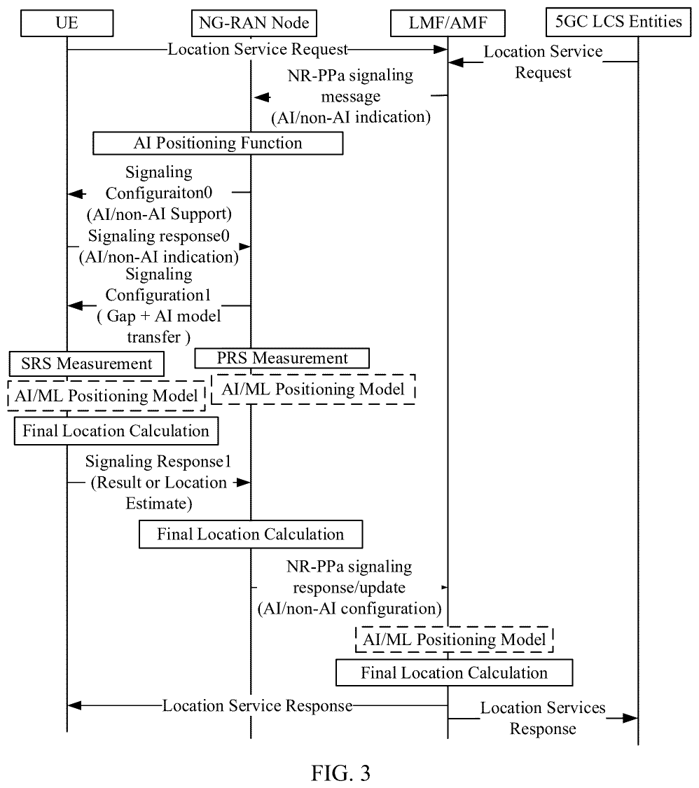

Considering the direct-AI positioning function is located at gNB, the procedure and interaction between the UE, LMF and the AI direct-positioning related function at gNB can be as depicted in FIG. 3 and given as follow:

The UE or an entity of core network (CN) (e.g., 5G location server) sends a positioning or location service request of a UE) to the entity responsible for final location estimation or calculation (i.e., location management function or LMF).

The LMF entity forwards or initiates a location estimation procedure request toward NG-RAN node or gNB (e.g., via NR-PPa signaling request), the request may contain an explicit or implicit indication related to at least one of the above-mentioned AI related positioning parameters.

Based on the indication, or internal NG-RAN node configuration, the node may request UE (e.g., via an RRC signaling configuration0) to provide a location information including an explicit indication regarding it requirements to enable or support of AI based positioning method or implicit indication based on the above parameters (or a requirement to provide a new measurement for support of AI model at gNB or LMF) or to indicate whether it has an AI positioning model or require model transfer from LMF or gNB.

The UE may response to the gNB request by providing a signaling configuration0 response message containing an explicit or implicit indication about AI model support and/or model transfer information.

Based on the indication signaling configuration0 response message form the UE or the indication provided by the LMF to gNB, the gNB or the AI-based related positioning function at gNB, the gNB may decide to either provide/configure via a signaling configuration1, an either a positioning reference signal (PRS) or positioning sounding reference signal (SRS) measurement gap configuration, measurement object and/or measurement indication configurations for AI-based or non-AI positioning method, or to alternatively combines between providing these two type of configuration according to the indication to guarantee others (a positioning KPI or to reduce signaling overhead or to guarantee a fallback to non-AI model to allow selecting between different AI positioning model upon a UE scenario or conditions change or). Additionally, the gNB may also configure to transfer an AI positioning inference model information/configuration, or to transfer inference input data to UE prior to transferring of AI based measurement object, indication or gap configuration. In another option, the gNB may provide via interface connecting between NG-RAN node and the AMF (i.e., NR-PPa signaling response), the AI/non-AI related information and the AI/non-AI based measurements received from UE to LMF for final location calculation. Optionally, the gNB may exchange the AI/non-AI positioning support information related to a UE with another RAN node over X2/Xn for support of a non-AI or AI positioning method at the other node.

Based on the on the configured measurement gap by the NG-RAN node, the UE may perform an AI/non-AI related measurement as fellows and report it back to gNB.

A direct AI-based measurement such as measuring the amplitude, time of arrival (TOA), Angle of Arrival (AoA), channel impulse response (CIR), Beam index, TRP index, power and/or reflection order of signal received from a gNB or multiple gNBs.

Alternatively, a non-AI based measurement, such as measuring DL-RSTD and UL-RTOA, DL PRS-RSRP and UL SRS-RSRP, UE Rx-Tx time difference and gNB Rx-Tx time difference,, UL-AoA or ZoA or AoD values per path.

After receiving the signaling configuration1 from the gNB, the UE may response with a signaling response1 containing a measurement report to the gNB or to LMF for final location estimation, or it may perform the location estimation or inference locally at UE in case that the AI model is deployed at UE or is transferred from LMF or gNB.

Embodiment 2: The signaling and procedures considering the direct-Ai positioning function is located at LMF:

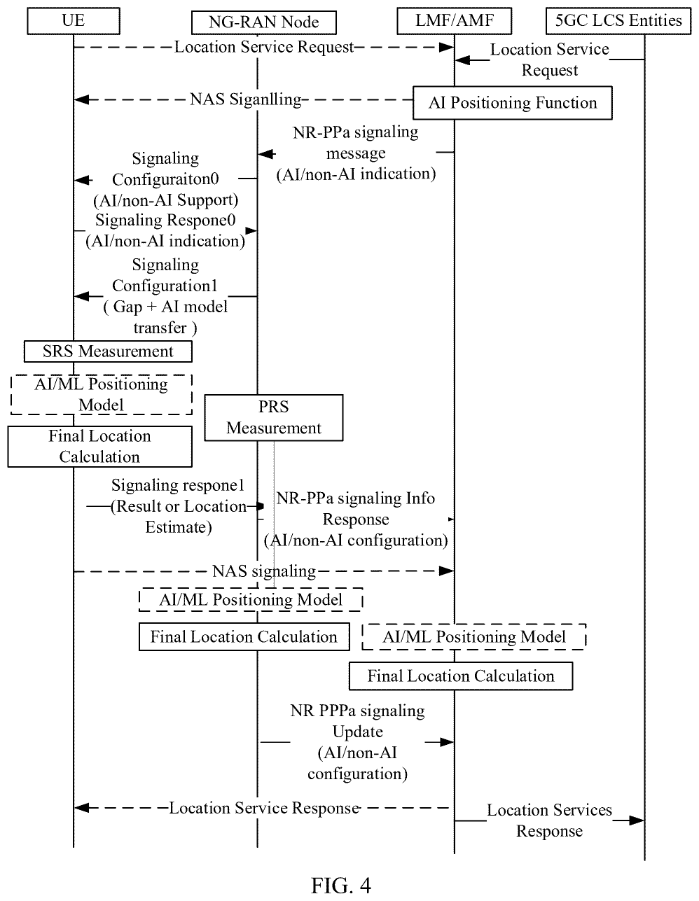

Considering the direct-AI positioning function is located at LMF, the procedure and interaction between the UE, LMF and the AI direct-positioning related function at LMF can be depicted in (FIG. 4) and given as follow:

The UE or an entity of core network (CN) (e.g., 5G location server) sends a positioning or location service request of a UE) to the entity responsible for final location estimation or calculation (i.e., location management function or LMF).

The LMF entity forwards or initiates a location estimation procedure request toward the gNB, (e.g., via NR-PPa signaling request) or optionally toward UE (e.g., via a non-access (NAS) signaling), the request may contain a request or inquiry regarding support or activating/deactivating a direct AI positioning method at RAN entity (e.g., gNB or UE).

Based on the request from the LMF entity, the gNB may request UE (e.g., via an RRC signaling configuration0) to provide a location information including an explicit indication regarding it requirements to enable or support of a direct AI based positioning method or implicit indication based on the above parameters (or a requirement to provide a new measurement for support of a direct AI model at gNB or LMF], or to indicate whether it has an AI positioning model or requires a model transfer from LMF or gNB.

The UE may response to the gNB request by providing a signaling configuration0 response message containing an explicit or implicit indication about AI model support/activation/deactivation and/or model transfer information.

Based on the indication signaling configuration0 response message form the UE and the indication provided by the LMF to gNB, the gNB may decide to provide/configure via a signaling configuration1, either a positioning reference signal (PRS) or positioning sounding reference signal (SRS) measurement gap configuration, measurement object and/or measurement indication configurations for AI-based or non-AI positioning method or to alternatively combines between providing these two type of configuration according to the indication to guarantee others (positioning KPI) or to reduce signaling overhead or to guarantee a fallback to non-AI model when the conditions change or to allow selecting between different AI positioning models. Additionally, the gNB may also indicate to LMF to transfer an AI positioning inference model information/configuration, or to transfer inference input data to UE prior to transferring of AI based measurement object, indication or gap configuration. In another option, the gNB may provide via interface connecting between NG-RAN node and the AMF (i.e., NR-PPa signaling response), the AI/non-AI related information and the AI/non-AI based measurements received from UE to LMF for model transfer and/or final location calculation. Optionally, the gNB may exchanges the AI/non-AI positioning support information related to a UE with another RAN node over X2/Xn for support of a non-AI or AI positioning method at the other node.

Based on the on the configured measurement gap by the NG-RAN node, the UE may perform an AI/non-AI related measurement as fellows and reports it back to gNB or provides it to MF via (NAS) signaling.

A direct AI-based measurement such as measuring the amplitude, time of arrival (TOA), Angle of Arrival (AoA), channel impulse response (CIR), Beam index, TRP index, power and/or reflection order of signal received from a gNB or multiple gNBs.

Alternatively, a non-AI based measurement, such as measuring DL-RSTD and UL-RTOA, DL PRS-RSRP and UL SRS-RSRP, UE Rx-Tx time difference and gNB Rx-Tx time difference, UL-AoA & ZoA or AoD values per path.

After receiving the signaling configuration1 from the gNB, the UE may response with a signaling response1 containing a measurement report to the gNB or to LMF for final location estimation or it may perform the location estimation or inference locally at UE in case that the AI model is deployed at UE or is transferred from LMF or gNB.

Embodiment 3: No UE-Network collaboration and the Direct-AI positioning model is located at UE side:

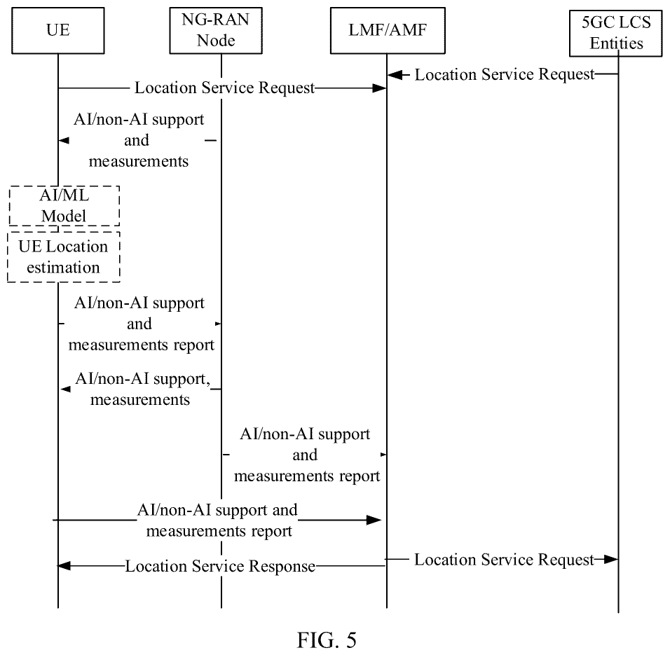

This case is assumed for the scenario where the accuracy requirement is high and the AI model is deployed at UE as given in FIG. 5, the direct AI related is supposed to either at gNB or LMF. In this case the gNB instructs UE to do measurement, and provide indication to UE to either run model to estimate location, and respond with estimated location, or optionally provide the parameters for location calculation to LMF, or to provide a pure measurement to LMF to calculate the final UE location. Then the LMF provide the final location estimate to the entity requesting the UE location.

Embodiment 4: No UE-Network collaboration and the Direct-AI positioning model is located at gNB side:

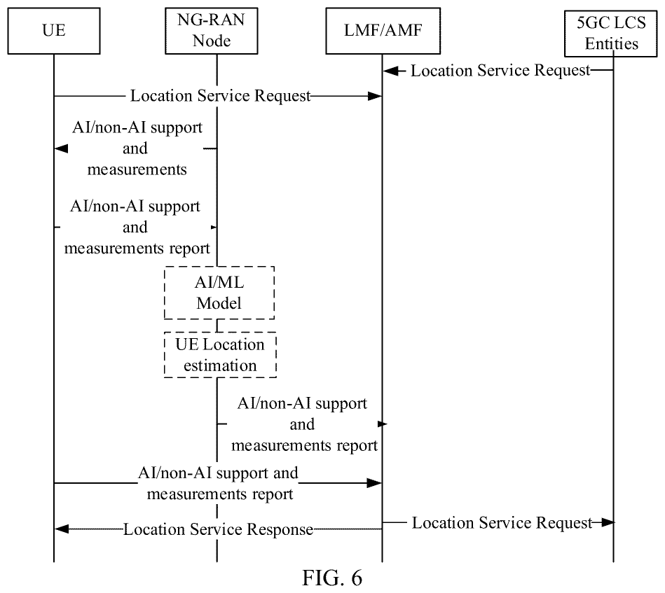

This case is also assumed for the scenario where the accuracy requirement is high and the AI model is deployed at UE as given in FIG. 6, the direct AI related is supposed to either at gNB or LMF. In this case the gNB or LMF instructs UE to do measurement a report back to gNB, based on the measurement, gNB may run AI model to inference the location and provide the final location estimate to LMF, or may provide a pure measurement to LMF to calculate/estimate the final location using the legacy positioning procedure. Then, it may provide the final location estimate to the entity requesting the UE location.

Embodiment 5: No UE-Network collaboration and the Direct-AI positioning model is located at LMF side:

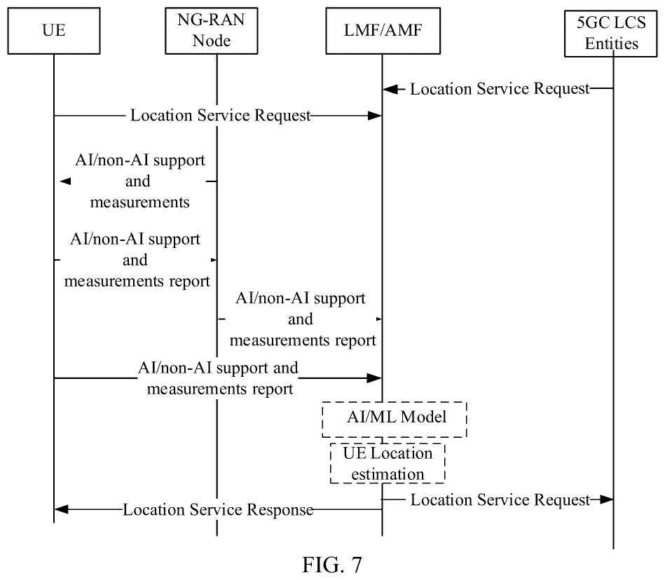

This case is also assumed for the scenario where the accuracy requirement is high and the AI model is deployed at UE as given in FIG. 7, the direct AI related is supposed to either at gNB or LMF. In this case, the gNB or LMF may instructs UE to measurement a report back to gNB, gNB provide the measurement along with indication to use AI/non-AI model, to LMF and LMF according to the indication performs either AI or non-AI based location calculation. Then, the UE provides the final location estimate to the entity requesting the UE location.

Embodiment 6: Collaborative option with AI model transfer from gNB to UE:

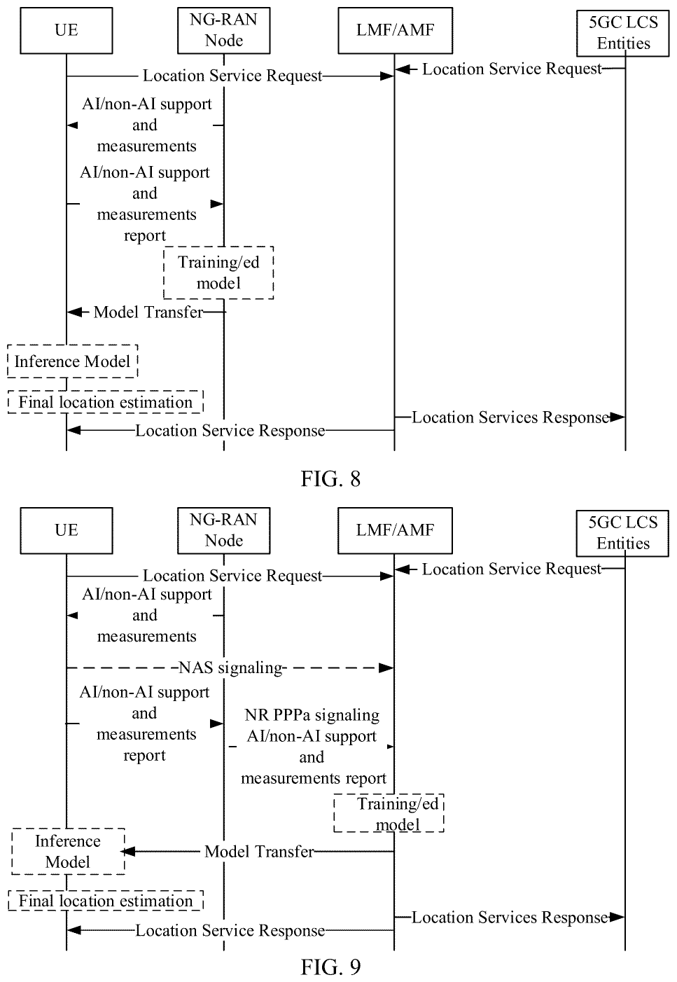

This case is assumed for the scenario where the accuracy requirement is high, UE has no AI model, but it supports AI model, and the latency can satisfy model downloading in FIG. 8. In this case, the gNB may instruct UE to provide AI model transfer related information to gNB. Then, the gNB transfers the required direct AI positioning AI model to the UE and configures the UE to do an AI based measurement gap/object for UE and instruct UE do measurement and/or to calculate the required location or provide AI based to LMF to do final location.

Embodiment 7: Collaborative option with AI model transfer from network to UE:

This case is assumed for the scenario where the accuracy requirement is high, UE has no AI model, but it supports AI model, and the latency can satisfy model downloading in FIG. 9. In this case, the gNB may instruct the UE to provide AI model transfer related information to the gNB or to the LMF directly via NAS signaling. Then, the g NB request the LMF to transfer the required direct AI positioning AI model to the UE. Additionally, the gNB configures the UE to do an AI based measurement gap/object for UE and instructs the UE to do measurement and to calculate the final UE location and provides the final UE location estimate to the LMF.

Embodiment 8: The signaling messages and indications:

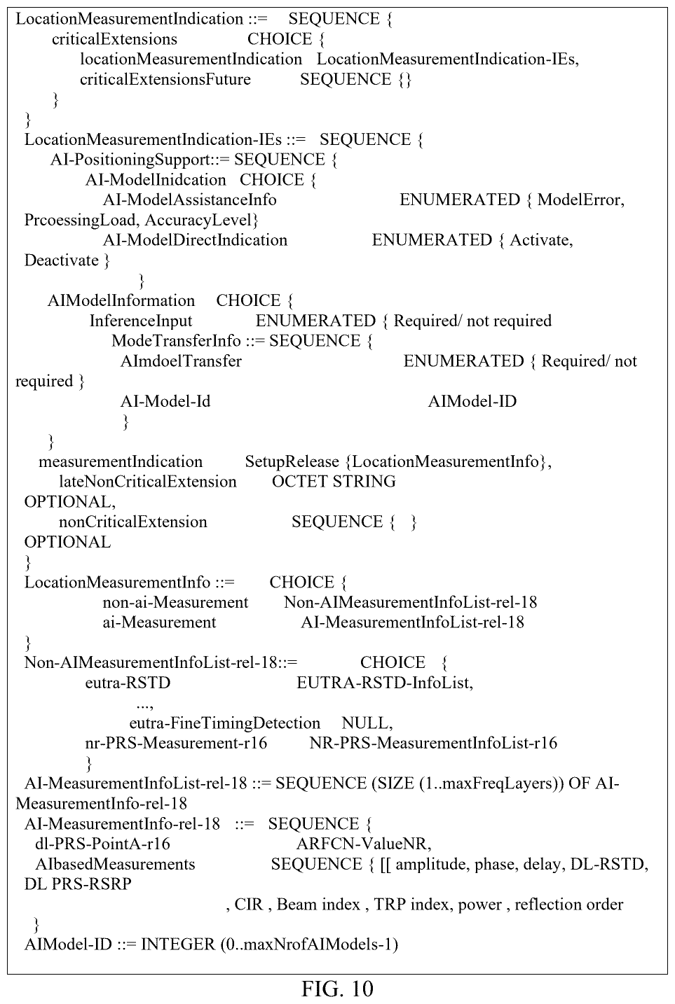

In the above method, the explicit or implicit indication is provided by UE to NG-RAN node via the air interface is an RRC signaling response0 messages sent from the UE to the gNB on the uplink logical channel. The RRC signaling response0 message could optionally be either a class one message such as and UL information transfer RRC message, location measurement indication RRC message, or UE assistance information RRC message, or a class two message such as UE Information response RRC message or UE positioning assistance information a new RRC message defined for AI positioning integration. The RRC signaling response0 messages may contain explicit AI positioning model indication such assistance information about model error, processing load and/or accuracy level indication which gNB or LMF may uses as indication to activate or deactivate the AI positioning model for the given UE (as indicated by AI-ModelAssistanceInfo IE within the messages). The indication may also contain a direct request for AI mode activation or deactivation (as indicated by in AI-ModelDirectIndication IE within the RRC response0 messages). The RRC signaling response0 message may also contain additional information to indicate to gNB whether an AI model inference input transfer is required or an AI positioning model transfer is needed to the given UE (as indicated by InferenceInput IE and Mode TransferInfo IE in the IModelInformation IE within the RRC response0 messages) and if so, the UE may indicate the requirement of model transfer and/or provide the model ID to gNB. The RRC signaling response0 message may also contain information about which type of measurement the gNB may configure to the given UE a measurement for support or AI positioning method or for non-AI based positioning method as given in Non-AIMeasurementInfoList-rel-18 and AI-MeasurementInfoList-rel-18 information elements. On the response to measurement type indication, the gNB may configure a measurement gap, a measurement configuration and/or one or more measurement objects for the support of AI or non-AI positioning method. An example of for the explicit or implicit indication provided within a location measurement indication RRC message is provided as given in FIG. 10.

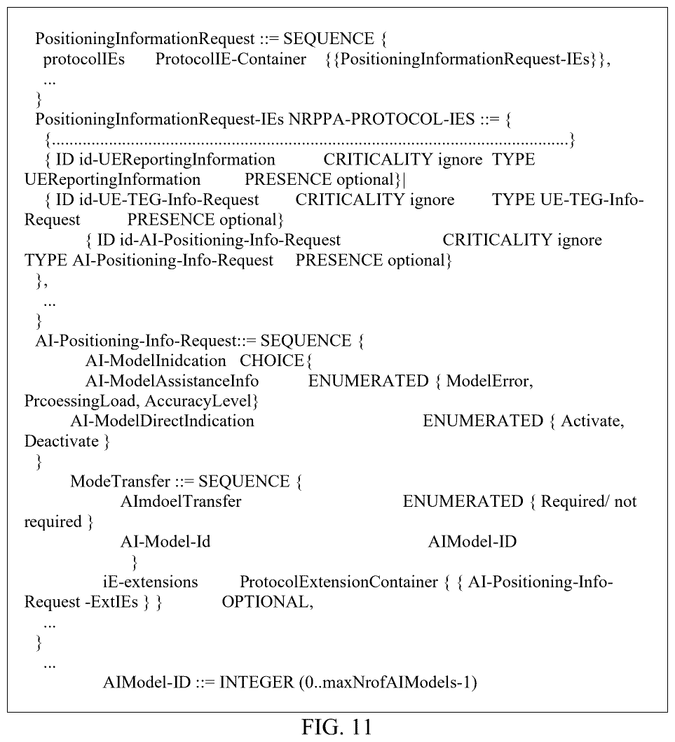

In the above method, the explicit or implicit indication is provided by the LMF/AMF entity of the core network to NG-RAN via NR positioning protocol A NR-PPa signaling message. An NR-PPa signaling request message could be either a positioning information request/update message or a measurement initiation request message or a positioning activation request message or a newly NR-PPA signaling message defined for the purpose of exchanging AI/non-AI positioning methods related information from LMF/AMF to NG-RAN node. The NR-PPa signaling message may contain explicit AI positioning model indication such assistance information about model error, processing load and/or accuracy level indication which gNB or LMF may use as indication to activate or deactivate the AI positioning model for the given UE (as indicated by in AI-ModelAssistanceInfo IE within the NR-PPa signaling messages). The NR-PPa signaling message may also contain a direct request for AI mode activation or deactivation (as indicated by AI-ModelDirectIndication IE within the within the NR-PPa signaling messages). The NR-PPa signaling message may also contain additional information to indicate to gNB whether an AI model inference input transfer is required or a positioning AI model transfer is needed to the given UE (as indicated by ModeTransferInfo IE and InferenceInput IEs within AIModelInformation IE within the within the NR-PPa signaling messages) and if so, the UE may indicate the requirement of model transfer (as indicated by AImdoelTransfer IE) and/or provide the required model ID to gNB(as indicated by AI-Model-Id IE) . An example of the explicit or implicit indication provided within a positioning information request NR-PPa messages from LMF to NG-RAN node is illustrated as given in FIG. 11.

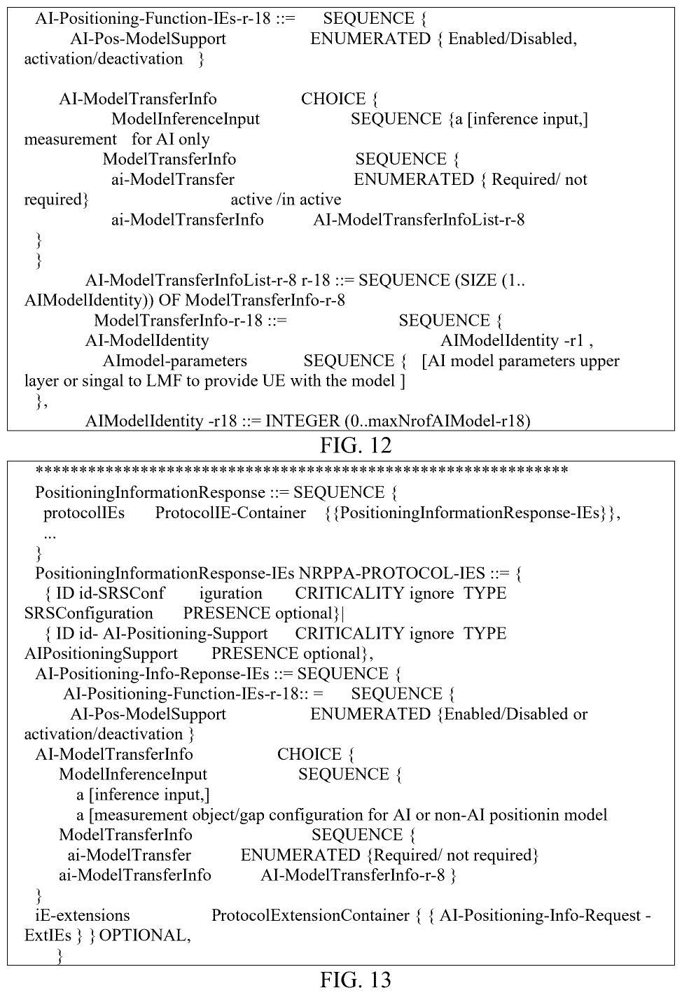

In the above method, the RRC signaling configuration0 or RRC signaling configuration1 for AI model transfer or measurement gap transfer from the NG-RNA node to UE can be either an RRC setup, reconfiguration or RRC resume or RRC Release or RRC Reestablishment or RRC logged measurement configuration message or a new RRC massage defined for the propose of exchanging AI positioning related information from gNB to UE. The RRC signaling configuration0 massage may contain information about AI positioning activation and deactivation information (as indicated by AI-Pos-ModelSupport IE within the RRC configuration0 massage) , the AI model inference input configuration (as indicated by ModelInferenceInput IE within the RRC configuration0 massage) and/or the AI positioning model transfer configuration information such as an enquiry about whether a model transfer is required from gNB for a given UE and/or the set of the models from which a UE can select the appropriate one (as indicated by ModelTransferInfo IE within the RRC configuration0 massage) . An example of the RRC signaling configuration0 message which carry AI positioning related information from gNB to UE is given in FIG. 12.

In the above method, the NR-PPa signaling response or update message for transferring AI/non AI model transfer information from gNB to LMF could be either a positioning information response or positioning information update message or a newly defined NR-PPa signaling message transmitted from gNB to LMF for the purpose of exchanging AI/non-AI positioning methods related information from NG-RAN node to LMF. the NR-PPa signaling response or update message may contain information about AI positioning activation and deactivation information (as indicated by AI-Pos-ModelSupport IE within the NR-PPa signaling response/update message), the AI model inference input configuration (as indicated by ModelInferenceInput IE within the NR-PPa signaling response/update massage) and/or the AI positioning model transfer configuration information such as an enquiry about whether a model transfer is required from gNB for a given UE and/or the set of the models from which a UE can select the appropriate one (as indicated by ModelTransferInfo IE within the NR-PPa signaling response/update massage). An example of NR-PPa signaling response or update message carrying AI positioning related information transmitted from LMF to gNB or to the UE as given in FIG. 13.

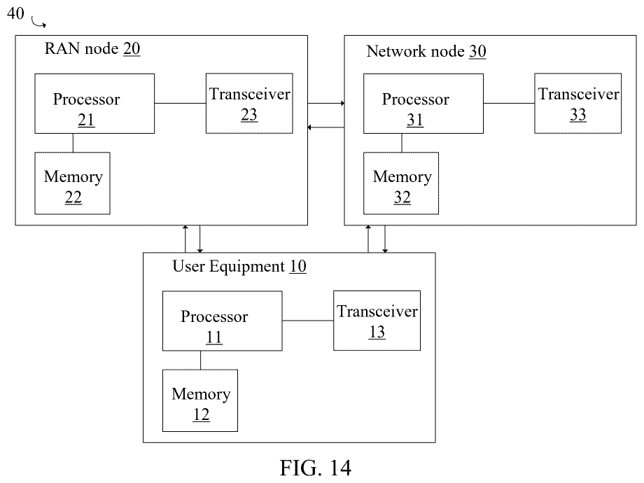

FIG. 14 illustrates that, in some embodiments, one or more user equipments (UEs) 10, a RAN node (e.g., gNB) 20, and a network node (e.g., LMF or AMF) 30 for communication in a communication network system 40 according to an embodiment of the present disclosure are provided. The communication network system 40 includes the one or more UEs 10, the RAN node 20, and the network node (e.g., LMF or AMF) node 30. The one or more UEs 10 may include a memory 12, a transceiver 13, and a processor 11 coupled to the memory 12 and the transceiver 13. The RAN node 20 may include a memory 22, a transceiver 23, and a processor 21 coupled to the memory 22 and the transceiver 23. The network node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

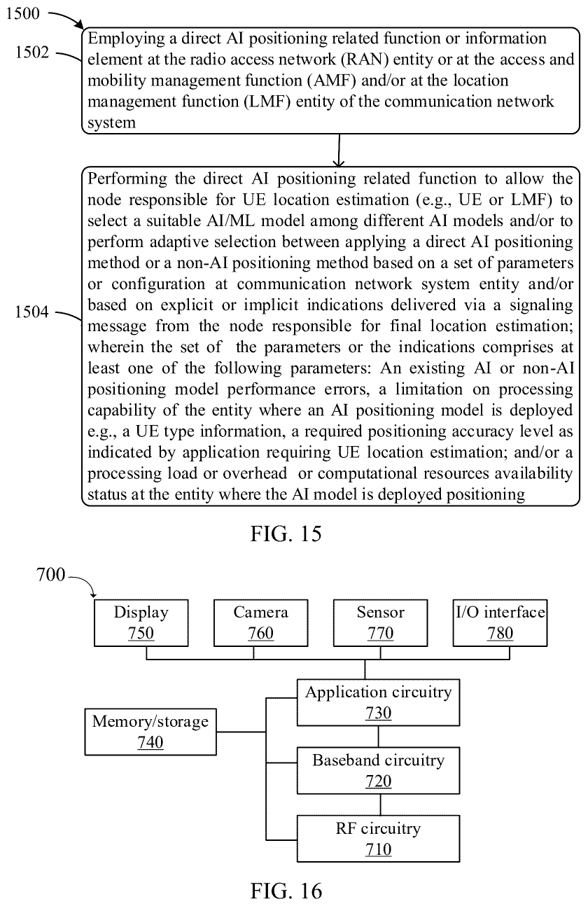

FIG. 15 is a flowchart illustrating a method for direct AI/ML based positioning model for user equipment (UE) location estimation performed by communication network system 40 according to an embodiment of the present disclosure. FIG. 15 illustrates that in some embodiments, the method includes a step 1502, employing a direct AI positioning related function or information element at the radio access network (RAN) entity or at the access and mobility management function (AMF) and/or at the location management function (LMF) entity of the communication network system, and a step 1504, performing the direct AI positioning related function to allow the node responsible for UE location estimation (e.g., UE or LMF) to select a suitable AI/ML model among different AI models and/or to perform adaptive selection between applying a direct AI positioning method or a non-AI positioning method based on a set of parameters or configuration at communication network system entity and/or based on explicit or implicit indications delivered via a signaling message from the node responsible for final location estimation; wherein the set of the parameters or the indications comprises at least one of the following parameters: An existing AI or non-AI positioning model performance errors, a limitation on processing capability of the entity where an AI positioning model is deployed e.g., a UE type information, a required positioning accuracy level as indicated by application requiring UE location estimation; and/or a processing load or overhead or computational resources availability status at the entity where the AI model is deployed positioning.

In summary, some embodiments of this disclosure provide a method which relies on introducing a new AI based positioning related function at NG-RAN or LMF node that allows UE to adaptively select between applying an AI and non-AI positioning model, defining within thin the function the measures based on which an AI or non-AI model can be selected for positioning estimation, and defining the related signaling procedures that allow proper interaction between UE, NG-RAN and the LMF entity. The major advantages of the method provided in some embodiments of the present disclosure include: 1. The new methods introduce a mechanism that allows a configurable selection of applying AI or non-AI based positioning method which could be best option to guarantee a tradeoff between accuracy levels and network efficiency, signaling overhead and complexity that could be brought by adopting the AI-based model accuracy level. 2. The new method allows to flexibility to support AI, non-AI methods, selects between different Ai models or to adaptively combine between these methods for allowing per UE model selectivity (e.g., selecting best model or a model with less error in case of multiple models) and/or to guarantee a fallback to non-AI model whenever needed (e.g., in case of model performance errors when changing scenarios). 3. The new method helps avoiding exchanging unnecessary AI model related information on more than one network interface. For example, for the case that the AI positioning model is at UE or LMF, the AI model related information shall be exchanged across both the interface between UE and NG-RAN node and the interface between NG-RAN node and LMF nodes. The method helps avoiding this phenomenon. 4. The new method reuses the existing NR positioning signaling and procedure which reduce the specification impact of integrating AI for positioning as much as possible.

FIG. 16 is a block diagram of an example system 700 for wireless communication according to an embodiment of the present disclosure. Embodiments described herein may be implemented into the system using any suitably configured hardware and/or software. FIG. 16 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for direct artificial intelligence/machine learning (AI/ML) based positioning model for user equipment (UE) location estimation performed by a communication network system, comprising:
a method for direct AI/ML based positioning model for user equipment (UE) location estimation employing a direct AI positioning related function or information element at a radio access network (RAN) entity or at an access and mobility management function (AMF) and/or at a location management function (LMF) entity of the communication network system, wherein the direct AI positioning related function allows a node responsible for UE location estimation to select a suitable AI/ML model among different AI models and/or to perform adaptive selection between applying a direct AI positioning method or a non-AI positioning method based on a set of parameters or configuration at the communication network system entity and/or based on explicit or implicit indications delivered via a signaling message from a node responsible for final location estimation; wherein the set of the parameters or the indications comprises at least one of the following parameters: an existing AI or non-AI positioning model performance errors, a limitation on processing capability of the entity where an AI positioning model is deployed, a required positioning accuracy level as indicated by application requiring UE location estimation; and/or a processing load or overhead or computational resources availability status at the entity where the AI model is deployed positioning.

2. The method according to claim 1, further comprising employing a different level of procedure and interaction between a UE, the LMF entity, and a related AI direct positioning function to support different options for direct AI positioning location and different collaboration levels.

3. The method according to claim 2, wherein employing the different level of procedure and interaction between the UE, the LMF entity, and the related AI direct-positioning function comprises a procedure considering the direct AI positioning function located at the gNB.

4. The method according to claim 3, wherein the procedure considering the direct AI positioning function located at the gNB comprises:
the UE or a core network (CN) sending a positioning or location service request of the UE to the LMF entity;
the LMF entity forwarding or initiating a location estimation procedure request toward a next generation radio access network (NG-RAN) node or the gNB, wherein the location estimation procedure request contains an explicit or implicit indication related to the at least one of AI positioning parameters;
based on the explicit or implicit indication or an internal NG-RAN node configuration, the NG-RAN node requesting the UE to provide a location information including the explicit indication regarding its requirements to enable or support of a AI based positioning method, the implicit indication based on the at least one of AI positioning parameters, or a requirement to provide a new measurement for support of an AI model at the gNB or the LMF entity or to indicate whether it has an AI positioning model or require a model transfer from the LMF entity or the gNB;
the UE responding to the gNB request by providing a signaling configuration0 response message containing an explicit or implicit indication about AI model support and/or model transfer information;
based on the indication signaling configuration0 response message form the UE or the indication provided by the LMF entity to the gNB, the gNB or the AI based related positioning function at the gNB, deciding to either provide/configure via a signaling configuration1, an either a positioning reference signal (PRS) or positioning sounding reference signal (SRS) measurement gap configuration, measurement object and/or measurement indication configurations for AI based or non-AI positioning method, or to alternatively combine between providing the two type of configurations according to the indication to guarantee others comprising a positioning KPI or to reduce signaling overhead or to guarantee a fallback to non-AI model when the conditions change or to allow selecting between different AI positioning models;
based on the configured measurement gap by the NG-RAN node, the UE performing an AI/non-AI related measurement and report the AI/non-AI related measurement back to the gNB; and
after receiving the signaling configuration1 from the gNB, the UE responding with a signaling response1 containing a measurement report to the gNB or to the LMF entity for final location estimation or the UE performing the location estimation or inference locally at the UE in case that the AI model is deployed at the UE or is transferred from the LMF entity or the gNB.

5. The method according to claim 4, wherein the gNB configuring to transfer an AI positioning inference model information/configuration or to transfer inference input data to the UE prior to transferring of AI based measurement object, indication or gap configuration.

6. The method according to claim 4, wherein the gNB providing via interface connecting between the NG-RAN node and an AMF, the AI/non-AI related information and the AI/non-AI based measurements received from the UE to the LMF entity for final location calculation.

7. The method according to claim 6, wherein the AI/non-AI based measurements comprises:
a direct AI-based measurement comprising measuring an amplitude, a time of arrival (TOA), an angle of arrival (AA), a channel impulse response (CIR), a beam index, a TRP index, a power and/or a reflection order of signal received from the gNB or multiple gNBs; or
a non-AI based measurement comprising measuring a DL-RSTD and an UL-RTOA, a DL PRS-RSRP and an UL SRS-RSRP, a UE Rx-Tx time difference and a gNB Rx-Tx time difference, a DL PRS-RSRPP and an UL SRS-RSRPP, and/or UL-AOA and ZOA values per path.

8. The method according to claim 6, wherein the gNB exchanging the AI/non-AI positioning support information related to the UE with another RAN node over X2/Xn for support of the non-AI or AI positioning method at the other node.

9. The method according to claim 2, wherein employing the different level of procedure and interaction between the UE, the LMF entity, and the related AI direct-positioning function comprises a procedure considering the direct AI positioning function located at the LMF entity.

10. The method according to claim 9, wherein the procedure considering the direct AI positioning function located at the LMF entity comprises:
the UE or a core network (CN) sending a positioning or location service request of the UE to the LMF entity;
the LMF entity forwarding or initiating a location estimation procedure request toward the gNB or the UE, wherein the location estimation procedure request contains a request or inquiry regarding support or activating/deactivating a direct AI positioning method at an RAN entity;
based on the request from the LMF entity, the gNB requesting the UE via an RRC signaling configuration0 to provide a location information including an explicit indication regarding its requirements to enable or support of a direct AI based positioning method or implicit indication based on the at least one of AI positioning parameters, or a requirement to provide a new measurement for support of an AI model at the gNB or the LMF entity or to indicate whether it has an AI positioning model or require a model transfer from the LMF entity or the gNB;;
the UE responding to the gNB request by providing a signaling configuration0 response message containing an explicit or implicit indication about AI model support and/or model transfer information;
based on the indication signaling configuration0 response message form the UE or the indication provided by the LMF entity to the gNB, the gNB deciding to either provide/configure via a signaling configuration1, an either a positioning reference signal (PRS) or positioning sounding reference signal (SRS) measurement gap configuration, measurement object and/or measurement indication configurations for AI based or non-AI positioning method, or to alternatively combine between providing the two type of configurations according to the indication to guarantee others comprising a positioning KPI or to reduce signaling overhead or to guarantee a fallback to non-AI model when the conditions change or to allow selecting between different AI positioning models;
based on the configured measurement gap by the NG-RAN node, the UE performing an AI/non-AI related measurement and report the AI/non-AI related measurement back to the gNB; and
after receiving the signaling configuration1 from the gNB, the UE responding with a signaling response1 containing a measurement report to the gNB or to the LMF entity for final location estimation or the UE performing the location estimation or inference locally at the UE in case that the AI model is deployed at the UE or is transferred from the LMF entity or the gNB.

11. The method according to claim 2, wherein employing the different level of procedure and interaction between the UE, the LMF entity, and the related AI direct-positioning function comprises a procedure considering no UE-network collaboration and the direct AI positioning model located at the UE.

12. The method according to claim 11, wherein the procedure considering no UE-network collaboration and the direct AI positioning model located at the UE comprises the gNB instructing the UE to do measurement and providing an indication to the UE to either run model to estimate location and respond with the estimated location, or providing the parameters for location calculation to the LMF entity, or providing a pure measurement to the LMF entity to calculate the final UE location, and the LMF entity providing the final location estimate to the entity requesting the UE location.

13. The method according to claim 2, wherein employing the different level of procedure and interaction between the UE, the LMF entity, and the related AI direct-positioning function comprises a procedure considering no UE-network collaboration and the direct AI positioning model located at the gNB.

14. The method according to claim 13, wherein the procedure considering no UE-network collaboration and the direct AI positioning model located at the gNB comprises the gNB or the LMF entity instructing the UE to do measurement a report back to the gNB, based on the measurement, the gNB running an AI model to inference the location and providing the final location estimate to the LMF entity, providing a pure measurement to the LMF entity to calculate/estimate the final location using the legacy positioning procedure, and providing the final location estimate to the entity requesting the UE location.

15. The method according to claim 2, wherein employing the different level of procedure and interaction between the UE, the LMF entity, and the related AI direct-positioning function comprises a procedure considering no UE-network collaboration and the direct AI positioning model located at the LMF entity.

16. The method according to claim 15, wherein the procedure considering no UE-network collaboration and the direct AI positioning model located at the LMF entity comprises the gNB or the LMF entity instructing the UE to do measurement a report back to the gNB, based on the measurement, the gNB providing the measurement along with indication to use the AI/non-AI model, to the LMF entity, and the LMF entity according to the indication performing either AI or non-AI based location calculation, and the UE providing the final location estimate to the entity requesting the UE location.

17. The method according to claim 2, wherein employing the different level of procedure and interaction between the UE, the LMF entity, and the related AI direct-positioning function comprises a procedure considering a collaborative option with an AI model transfer from the gNB to the UE.

18. The method according to claim 17, wherein the procedure considering the collaborative option with the AI model transfer from the gNB to the UE comprising the gNB instructing the UE to provide AI model transfer related information to the gNB, transferring the required direct AI positioning AI model to the UE, configuring the UE to do an AI based measurement gap/object for the UE, and instructing the UE to do measurement and/or to calculate the required location or provide AI based to the LMF entity to do final location.

19. The method according to claim 2, wherein employing the different level of procedure and interaction between the UE, the LMF entity, and the related AI direct-positioning function comprises a procedure considering a collaborative option with an AI model transfer from a network to the UE.

20-27. (canceled)

28. A communication network system, comprising:
a memory;
a transceiver; and
a processor coupled to the memory and the transceiver;
wherein the processor is configured to execute a method for direct artificial intelligence/machine learning (AI/ML) based positioning model for user equipment (UE) location estimation, comprising:
a method for direct AI/ML based positioning model for user equipment (UE) location estimation employing a direct AI positioning related function or information element at a radio access network (RAN) entity or at an access and mobility management function (AMF) and/or at a location management function (LMF) entity of the communication network system, wherein the direct AI positioning related function allows a node responsible for UE location estimation to select a suitable AI/ML model among different AI models and/or to perform adaptive selection between applying a direct AI positioning method or a non-AI positioning method based on a set of parameters or configuration at the communication network system entity and/or based on explicit or implicit indications delivered via a signaling message from a node responsible for final location estimation; wherein the set of the parameters or the indications comprises at least one of the following parameters: an existing AI or non-AI positioning model performance errors, a limitation on processing capability of the entity where an AI positioning model is deployed, a required positioning accuracy level as indicated by application requiring UE location estimation; and/or a processing load or overhead or computational resources availability status at the entity where the AI model is deployed positioning.
